(19) United States
(12) Patent Application Publication
(10) Pub. No.: US 2026/0179832 A1
(43) Pub. Date: Jun. 25, 2026

(54) CONNECTION ELEMENT, METHOD FOR MOUNTING A CONNECTION ELEMENT, AND SENSOR ARRANGEMENT

(71) Applicant: Endress+Hauser Conducta GmbH+Co. KG, Gerlingen (DE)

(72) Inventors: Christian Boeck, Hartha (DE); Christian Fanselow, Geringswalde (DE); Thomas Höhne, Chemnitz (DE)

(21) Appl. No.: 19/424,935

(22) Filed: Dec. 18, 2025

(30) Foreign Application Priority Data
Dec. 20, 2024 (DE) 10 2024 139 164.2

(51) Int. Cl. H01F 38/14

(52) U.S. Cl. CPC H01F 38/14; H01F 2038/143

(57) ABSTRACT

A connection element for connection to a sensor includes: a coupling body which connects the connection element to the sensor, with an inductive interface for communication with the sensor and for supplying energy to the sensor; a base body; a locking part; and an annular closing element arranged therebetween, wherein the locking part is movable with respect to the base body at least between a first and a second position, wherein the sensor is connectable to and releasable from the connection element in the first position, wherein the sensor is locked to the connection element in the second position, wherein the locking part is mechanically coupled to the closing element, and wherein the closing element is designed to have a haptic detent behavior with the base body or the closure element and ensures end-position locking in the first and second positions.

### CROSS-REFERENCE TO RELATED APPLICATION

The present application is related to and claims the priority benefit of German Patent Application No. 10 2024 139 164.2, filed Dec. 20, 2024, the entire contents of which are incorporated herein by reference.

### TECHNICAL FIELD

The present disclosure relates to a connection element, a method for mounting a connection element, and a sensor arrangement comprising a connection element.

### BACKGROUND

In process automation, sensors are connected to a connection element by means of a mechanical coupling, often in the form of a bayonet mount. The connection element comprises a cable attachment and a cable. The cable, in turn, is connected to a higher-level unit, such as a measuring transducer or a control center. There is an interface on the sensor and on the connection element, designed for example inductively or optically, via which the sensor is supplied with energy and communication from the sensor to the connection element or to the higher-level unit is ensured. This is described, for example, in EP 1 625 643.

In this context, particular reference shall be made to the applicant's products called “Memosens.” Other generic designs are, for example, “Memosens” by the company Knick, “ISM” by Mettler-Toledo, the “ARC” system by Hamilton, and “SMARTSENS” by Krohne.

The sensors and connection elements currently used are plugged together axially and locked accordingly, for example, with a bayonet mount, as mentioned. Such a bayonet mount is described in WO 2004/102748, for example. In the connected condition, the housings of the sensor and of the connection element are in an axial arrangement in relation to one another. Furthermore, a sensor-side sensor element, e.g., an element for determining a pH value, as well as a cable-side connecting piece to the higher-level unit are also located in the axial direction of the respective interfaces. This results in an arrangement that, depending upon the sensor length, has a length of approximately 25 to 85 cm in the axial direction. The cable is largely flexible and can be up to 100 m long.

As mentioned, the connection element and sensors can be easily plugged together. They are compatible with one another both mechanically (via the corresponding housing or bayonet mount) and electrically (via the, for example, inductive or optical interfaces). DE 10 2015 112 949 A1 describes how sensors and connection elements that are compatible solely with one another can be used.

### SUMMARY

The object of the present disclosure is to further develop and improve the known sensor/connection element plug system.

The object is achieved by a connection element for connection to a sensor which is designed to detect a measured variable, wherein the connection element is designed to transmit a value dependent upon the measured variable to a higher-level unit, wherein the connection element comprises a coupling body which connects the connection element to the sensor, with an, in particular inductive, interface for communication with the sensor and for supplying energy to the sensor; a base body; a locking part; and an annular closing element arranged therebetween, wherein the locking part is rotatably movable with respect to the base body at least between a first and a second position, wherein the sensor is connectable to and releasable from the connection element in the first position, wherein the sensor is locked to the connection element in the second position, wherein the locking part is mechanically coupled to the closing element or closure element, and wherein the closing element is designed to have a haptic detent behavior with the base body and ensures end-position locking in the first and second positions.

Using an additional component (in comparison to the prior art) with an axial cam arrangement (closing element) has the effect that diameter changes resulting from manufacturing tolerances, anisotropy during injection molding, compound influences, potting influences, and process temperatures have no influence on the closing haptics and thus on the actuation torque to be applied by the user. No complex geometries, which are subject to possible wear, are required on the base body of the connection element, sensor, or locking part, which simplifies the injection molding tool.

Changes in stiffness resulting from material-specific fluctuations in the locking part or base body (e.g., additives or dyes) are decoupled by the closing element.

If adaptations to the closure haptics are desired (e.g., a change in the force required, noise level, customer customization), the adaptations can be made by simply changing the closing element, regardless of the base body and locking part.

At least one embodiment provides for the base body to comprise the interface.

At least one embodiment provides for the coupling body to comprise second locking means, which are designed to be complementary to the first locking means of the sensor and form, in particular, a bayonet mount.

At least one embodiment provides for the sensor to comprise a coupling body, wherein the coupling body of the sensor or of the connection element comprises at least one protrusion, wherein, by introducing the protrusion and the second locking means into the first locking means, in particular into a corresponding recess, of the respective other coupling body, and subsequently rotating the base body with respect to the locking part of the bayonet mount, the coupling bodies are locked.

At least one embodiment provides for the closing element to be designed as a not-fully-closed ring.

At least one embodiment provides for the closing element to be oval-shaped.

At least one embodiment provides for the base body including a guide surface for the closing element, wherein the closing element comprises cams in the axial direction of the connection element, which engage with a counter-geometry on the base body. The connection element according to the preceding claim, wherein the counter-geometry on the base body comprises a first stop surface for the first position and a second stop surface for the second position, and wherein the base body comprises a central cam which separates the first from the second position.

At least one embodiment provides for the closing element to be designed as a resilient element.

Such design as a resilient element can be realized in two ways.

The closing element is designed, for one, as a not-fully-closed ring (see above), which enables a “wear-free” (force-free) mounting.

For another, at least one embodiment provides for the closing element to be realized as a resilient element by means of a recess extending in sections along the circumference. The recess allows for a defined rigidity in order to reproducibly adjust the haptics for closing and opening the bayonet. This results in reduced wear. Haptics can be adjusted based upon the type of recess, too.

At least one embodiment provides for the central cam of the base body to be designed with the resilient design of the closing element so as to result in haptic detent behavior when moving from the first to the second position, or vice versa.

At least one embodiment provides for the locking part to comprise one or more drive elements which engage with one or more correspondingly designed receiving elements of the closing element and, when the locking part moves from the first to the second position, or vice versa, drives the closing element.

At least one embodiment provides for the receiving element to be designed as part of the cam, in particular, as a radial protrusion.

The axial locking of the locking part is decoupled from the closing element. There are at least two embodiments thereof.

At least one embodiment provides for the closing element to be conical, wherein the locking part correspondingly comprises an axial conical groove and a projection, and the locking part is axially secured relative to the base body by the projection on the wider part of the conical closing element.

At least one embodiment provides for the closing element to be designed at a right angle, wherein the locking part correspondingly comprises a cylindrical free surface, wherein a detent between the base body and the locking part secures the latter axially relative to the base body.

The object is further achieved by a method for mounting a connection element as described above, comprising the steps of: providing the base body; slipping the closing element over the base body; and slipping the locking part over the base body with the closing element in the axial direction.

The object is further achieved by a sensor arrangement comprising a connection element as described above, and a sensor with first locking means, which are designed to be complementary to the second locking means of the connection element.

In at least one embodiment, the closing element comprises an electronically evaluable reproduction of the end position.

In at least one embodiment, the closing element comprises a color coding for the respective end position.

### BRIEF DESCRIPTION OF THE DRAWINGS

The present disclosure is explained in more detail with reference to the following figures, in which:

FIG. 1 shows an overview of the sensor arrangement according to the present disclosure;

FIGS. 2a-2c show the sensor arrangement according to the present disclosure with a sensor (FIG. 2a) and connection element in an open state (FIG. 2b) and in a locked state (FIG. 2c);

FIGS. 3a and 3b show two embodiments for the connection element with the base body and the locking part, which is shown transparent for clarity such that the closing element is visible;

FIGS. 4a and 4b show a side view and a perspective view, respectively, of the base body of the connection element;

FIGS. 5a-5e show an embodiment of the closing element with the arrangement on the connection element with an axial locking function.

FIGS. 6a-d show an embodiment of the closing element with the arrangement on the connection element without an axial locking function.

FIGS. 7a-c show embodiments for the closing element.

FIG. 8 shows an embodiment of the closing element.

FIGS. 9a-c show the method of mounting the connection element.

FIG. 10a/b show one embodiment.

In the figures, the same features are labeled with the same reference signs.

### DETAILED DESCRIPTION

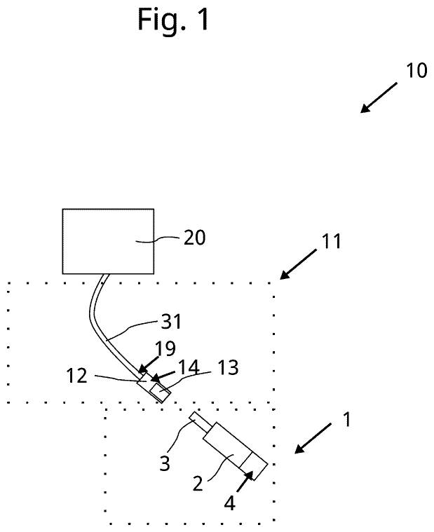

A sensor arrangement 10 according to the present disclosure includes a sensor 1 and a connection element 11, as shown in FIG. 1. The sensor 1 communicates with a higher-level unit 20 via a first interface 3. In the example, a transmitter is connected. The transmitter is in turn connected to a control system (not depicted). In at least one embodiment, sensor 1 communicates directly with a control system. A cable 31 is connected on the sensor side to transmitter 20, and its other end includes an interface 13 that is complementary to first interface 3. A connection element 11 includes cable 31, along with interface 13. The interfaces 3, 13 are configured as galvanically separate interfaces, e.g., as inductive interfaces, which can be coupled to one another by means of a mechanical plug connection. The mechanical plug connection is hermetically sealed, such that no fluid, such as the medium to be measured, air, or dust can enter from the outside.

Data (bidirectionally) and energy (unidirectionally, i.e., from the transmitter 20 to sensor 1) are sent via the interfaces 3, 13. The sensor arrangement 10 is used predominantly in process automation.

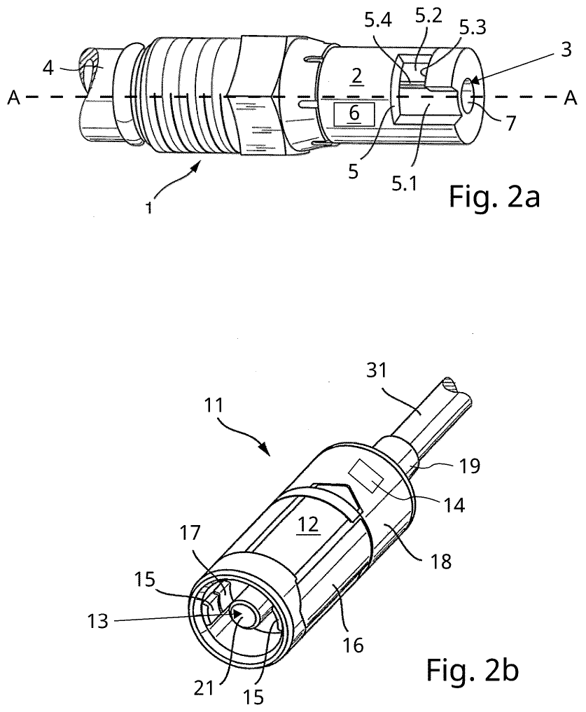

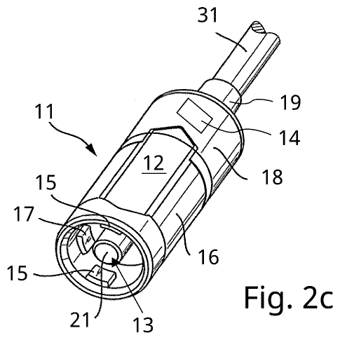

The sensor 1 thus comprises at least one sensor element 4 (only indicated in FIGS. 1 and 2a) for detecting a measured variable of process automation. The sensor 1 may be, for example, a pH sensor, also known as ISFET, generally an ion-selective sensor, a sensor for measuring redox potential, the absorption of electromagnetic waves in the medium, e.g., with wavelengths in the UV, IR, and/or visible ranges, oxygen, conductivity, turbidity, the concentration of non-metallic materials, or the temperature with the corresponding measured variable.

In the following, FIGS. 2a-2c will be discussed. The sensor 1 comprises a first coupling body 2, which comprises the first interface 3. As previously mentioned, first interface 3 is designed for the transmission of a value at a second interface 13 that is a function of the measured variable. The first interface 3 is designed as a groove 7 (see below). The sensor 1 may comprise a data processing unit 6, e.g., a microcontroller, which processes the values of the measured variable, e.g., converts them into a different data format. In this way, an averaging, pre-processing, and digital conversion can be performed by the data processing unit.

Sensor 1 can be connected via interfaces 3, 13 to connection element 11 and ultimately to a higher-level unit 20. As mentioned previously, the higher-level unit 20 is, for example, a transmitter or a control center. The data processing unit 6 converts the value that is a function of the measured variable into a protocol that can be understood by the transmitter or the control center. Non-limiting examples of this include the proprietary Memosens protocol, or else HART, wirelessHART, Modbus, Profibus Fieldbus, WLAN, ZigBee, Bluetooth, RFID, or others. This conversion can also be performed in a separate communications unit instead of in the data processing unit, wherein the communications unit is arranged on the side of the sensor 1 or the connection element 11. The aforementioned protocols also include wireless protocols, so that a corresponding communications unit includes a wireless module. First and second interfaces 3, 13 are thus designed for bidirectional communication between sensor 1 and higher-level unit 20. As mentioned, first and second interfaces 3, 13 also ensure the supply of power to sensor 1 along with the communication.

The connection element 11 comprises a second interface 13, wherein the second interface 13 is designed to be complementary to the first interface 3. The second interface 13 is designed as a bung 21 (e.g., a cylindrical boss). In at least one embodiment, the connection element 11 also comprises a data processing unit 14. The data processing unit 14 may serve as a repeater for the transmitted signal. Furthermore, the data processing unit 14 can convert or modify the protocol.

The connection element 11 includes a second, cylindrical coupling body 12 designed to be complementary to the first coupling body 2 and to be slipped onto a sleeve-like end section on the first coupling body 2, wherein the second interface 13 is plugged into the first interface 3. Where herein the term “coupling body” is used without further specification, it refers to the coupling body of the connection element 11, i.e., the second coupling body.

An opposite arrangement, in which second interface 13 has a sleeve-like design and first interface 3 a plug-like design, is possible without any inventive effort, as would be recognized by one of ordinary skill in the art of the present disclosure. In the sleeve-shaped end section of the second coupling body 12, at least two second locking means 15 extend radially inwards to engage with at least two first locking means 5, more precisely at least two angled recesses 5, on the lateral surface of the first coupling body 2 on the sensor 1, and to form a bayonet mount. The locking means 15 are rotated relative to the protrusions 17 after the locking means 15 have been inserted into the recesses 5 (see below).

The angled recesses 5 of the sensor 1 comprise an axial section 5.1 open to the end face of the coupling body 2 and an angled azimuthal section 5.2 spaced apart from the end face. The azimuthal section 5.2 comprises an axial stop surface 5.3, which faces the end face of the coupling body 2 and prevents the disconnection of the sensor 1 from the connection element 11 when the bayonet mount is locked. The axial stop surface 5.3 preferably comprises an azimuth-dependent axial contour, which causes the second coupling body 12, and thus the connection element 11, to be drawn more strongly to the first coupling body 2, and thus the sensor 1, when the bayonet mount is closed. Axial ribs 5.4 are moreover arranged in the at least two recesses 5, on which ribs the radially inward-directed lateral surfaces of the radially inward-extending locking means 15 rest with their angle-dependent contour. This ultimately brings about a locking against rotation as a result of a slightly elastic deformation of the sleeve-shaped end section.

The locking means 15 are formed in one piece with the second coupling body 12, for example, as an injection molded part.

The connection element 11 comprises a base body 18 which is cylindrical at least in sections and onto which a sleeve-like locking part 16 is fitted, wherein the locking part 16 is axially fixed with respect to the base body 18 (see below) and is freely movable in the azimuthal direction at least over an angular range required for closing and opening the bayonet mount.

Axial protrusions 17 extend from the section, facing away from the cable attachment 19, of the base body 18, which axial protrusions 17 each engage in an axial section 5.1 of the complementary recesses 5 on the first coupling element 5 when the connection element 11 is connected to the sensor 1.

The sleeve-like locking part 16 projects beyond the axial protrusions 17 in the axial direction. The protrusions 17 extend radially inwards from the inner wall of the locking part 16, wherein the protrusions serve as second locking means for the bayonet mount. The protrusions 17 are distributed over the circumference of the inner wall such that, upon appropriate adjustment of the azimuth angle between the locking part 16 and the base body 18, their azimuth position is aligned with the locking means 15, as shown in FIG. 2b. In this position, the second coupling body 12 can be slipped onto the first coupling body 2, wherein the radial protrusions 17 are arranged in the transition region between the axial section 5.1 and the azimuthal section 5.2 of the recesses 5 when the connection element 11 is slipped onto the sensor 1. By rotating the azimuth angle between the base body 18 and the locking part 16, the radial protrusions 17 are brought into the azimuthal section 5.2 of the recesses 5, whereby the bayonet mount is locked as shown in FIG. 2c. This is then referred to as the “locked state,” “closed state,” or first position. If the locking means 15 and protrusions 17 are aligned, this is referred to as the “unlocked state,” “open state,” or second position. In principle, more positions can be set, but two are advantageous—the open and the closed ones.

What is described above and shown in FIGS. 2a-2c essentially concerns the connection between sensor 1 and connection element 11. The further development of the sensor/connection element connection according to the present disclosure relates to a base body and locking part modified compared to the prior art, which, in conjunction with another part, viz., the closing element 41, results in better haptic feedback for the user of the sensor, a longer service life of the sensor arrangement 10, and simpler production.

The connection element 11 according to the present disclosure comprises the base body 18 and the locking part 16 in addition to the interface 13, wherein the locking part 16 is mechanically coupled to the closing element 41, and the closing element 41, in interaction with the base body 18, is designed to have a haptic detent behavior and ensures end-position locking in the first and second positions (i.e., the closed or open state).

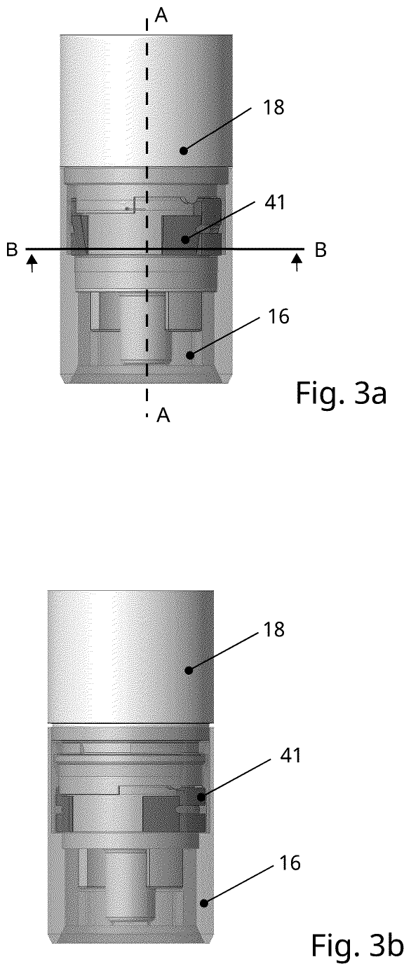

FIGS. 3a and 3b show two embodiments of the connection element 11 with the base body 18 and the locking part 16, which is shown transparent here for clarity such that the closing element 41 is visible. In the embodiment in FIG. 3a, an axial locking of the locking part 16 with respect to the base body 18 is integrated into the closing element 41. In the embodiment in FIG. 3b, this locking takes place directly between the locking part 16 and the base body 18. The locking part 16 and the closing element 41 are designed differently.

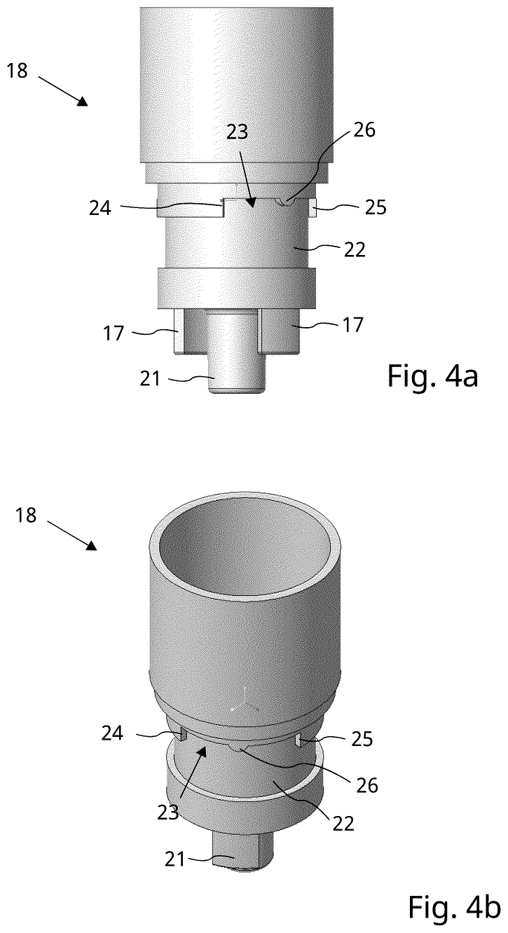

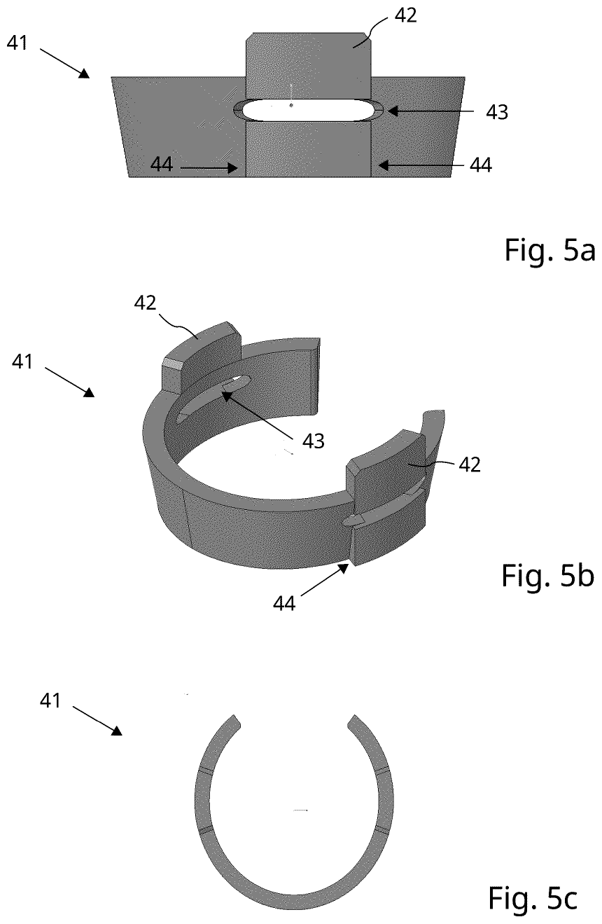

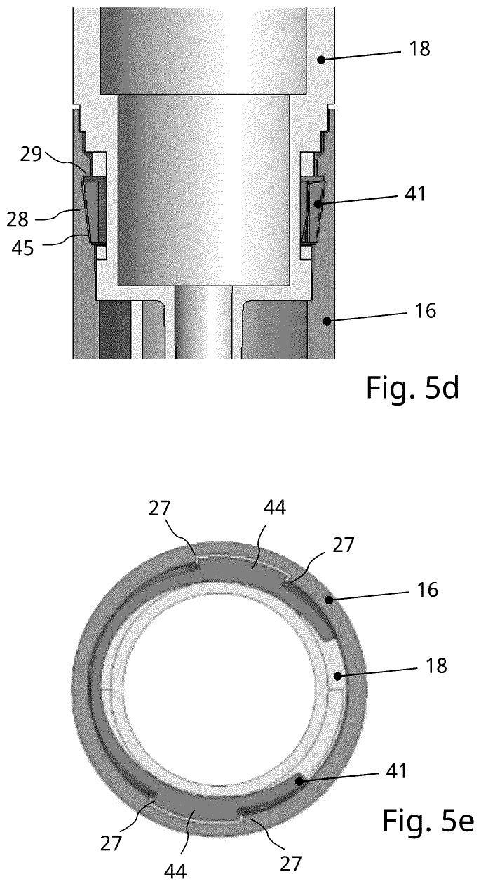

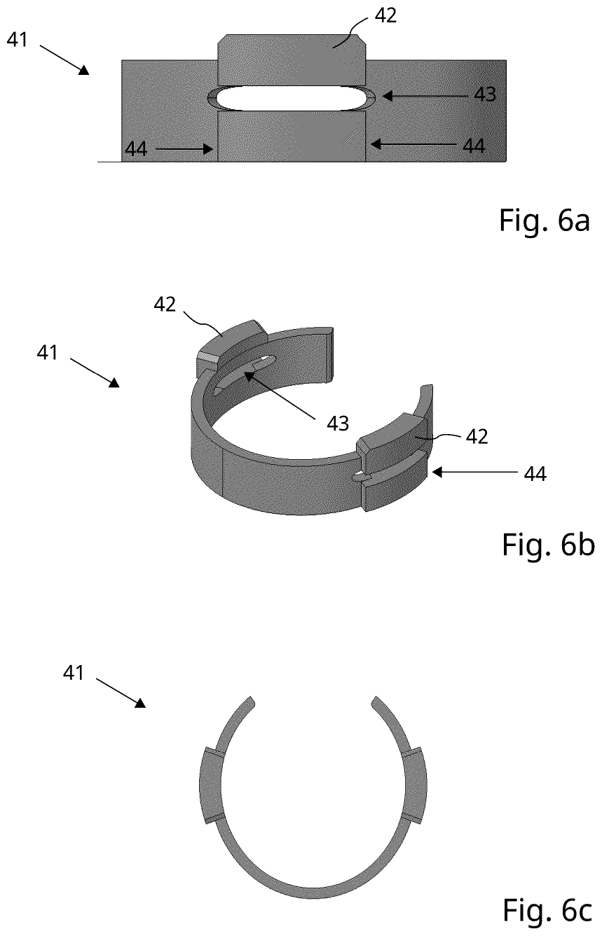

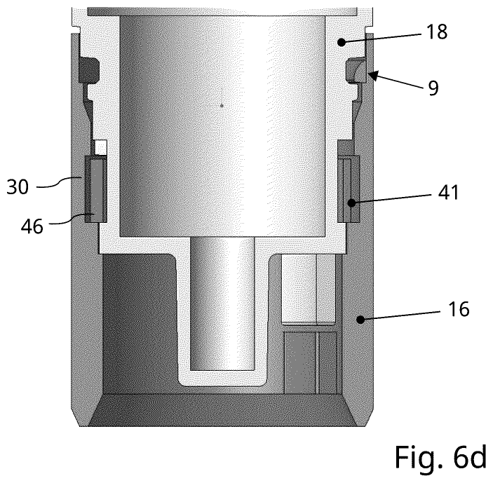

The base body 18 is shown in two views in FIGS. 4a and 4b. FIGS. 5a-5c show the closing element 41 in one embodiment; FIGS. 6a-6c show a further embodiment. FIG. 5d and FIG. 6d show the respective embodiment of the closing element 41 in interaction with the locking part 16.

The base body 18 comprises a guide surface 22 for the closing element 41. The closing element 41 has a not-fully-closed ring shape and engages in said guide surface 22 with its inner circumference. The closing element 41 is, for example, circular or oval-shaped.

The closing element 41 comprises one or more cams 42 in the axial direction, which engage with a counter-geometry 23 on the base body 18. As used herein, directions, such as radial, axial, azimuth, etc., are relative to the main axis of the sensor. The main axis is indicated by the dashed line A-A in FIG. 2a and FIG. 3a.

The counter-geometry 23 on the base body 18 has a first stop surface 24 for the first position and a second stop surface 24 for the second position. The base body 18 further comprises a central cam 26, which separates the first from the second position. The central cam 26 is located, for example, centrally between the first and second stops 24, 25. The central cam 26 can have any design. The figures show a semicircular design; more-angular variants, oval variants, or others are possible.

FIGS. 5a-5e show an embodiment of the closing element 41. The closing element 41 is designed to be resilient (reference sign 43), e.g., spring-loaded specifically in the axial direction. As shown, the resilient element 43 can be realized by a recess or aperture in the ring, for example, along the circumference. The recess can be designed to be, for example, circular, oval, rectangular with rounded corners, or otherwise. The recess enables a defined rigidity to reproducibly adjust the haptics for closing and opening the bayonet. This results in reduced wear.

The resilient element 43 together with the central cam 26 of the base body 18 is designed so as to result in a haptic detent behavior when moving from the first to the second position, or vice versa (i.e., when closing or opening the bayonet). Users moving the locking part 16 relative to the base body 18 thus experience a kind of “feedback”—e.g., users notice that the bayonet is “closed” or “open” and that the closing element 41 is in an end position (at stop 24 or 25).

For the locking part 16 to be able to move the closing element 41, i.e., to “entrain” or “drive” it, the locking part 16 comprises one or more drive elements 27 which engage with one or more correspondingly designed receiving elements 44 in the closing element 41 and, when the locking part 16 moves from the first to the second position, or vice versa, drives the closing element 41. The receiving element 44 can be designed as part of the cam 42, in particular, as a radial protrusion. FIG. 5e shows a section along line B-B (see FIG. 3a), in which the receiving elements 44 and the drive elements 27 can be seen.

In FIGS. 5a-5e, the closing element 41 is designed to be frustoconical (reference sign 45) on the non-closed part of the ring. In the embodiment in FIGS. 6a-6d, this part is straight; otherwise, FIGS. 5a-5c are the same as FIGS. 6a-6c.

In the frustoconical design (FIGS. 5a-5e), the locking part 16 comprises a corresponding axial conical groove 28 and a projection 29, and the locking part 16 is axially secured relative to the base body 18 by the projection 29 on the wider part of the frustoconical part 45 of the closing element 41. In other words, once the locking part 16 has been slipped over the base body 18 and the closing element 41 (see below for the mounting method), it can no longer fall out downwards. This is shown in FIG. 5d.

FIGS. 6a and 6b show an embodiment in which the closing element 41 is designed at a right angle on the non-closed part of the ring (reference sign 46; see FIG. 6d), wherein the locking part 16 correspondingly comprises a cylindrical free surface 30. In this embodiment, axial locking of the locking part 16 on the base body 18 is realized by a locking contour 9 on both parts. The closing element 41 lies securely on the base body 18; it does not secure the locking part 16. FIG. 6c shows the oval design of the closing element 41.

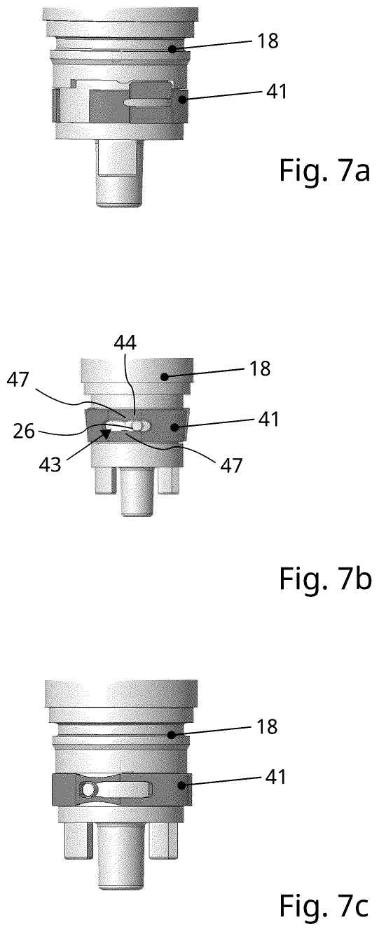

FIG. 7a shows an embodiment of the closing element 41 on the base body 18. This closing element 41 is the embodiment shown in FIGS. 6a-d.

FIGS. 7b and 7c show a further embodiment of the closing element 41 in which the central cam 26 is directed radially outwards (in contrast to, for example, the embodiment of FIGS. 4a and 4b, in which the central cam is directed axially). The closing element 41 comprises a recess 43. The central cam 26 engages with the recess 43. The recess 43 is, for example, spectacle-shaped as shown in FIG. 7b. The central cam 26 “slides” in the recess 43 when moving from the first to the second position, or vice versa. The closing element 41 itself has one or two cams 47 over which the cam 26 slides. This provides haptic feedback for the user. When crossing the cams 26, 47, the closing element 41 is stretched in the axial direction. The cam(s) 47 can divide the recess 43 in half as shown in FIG. 7b. However, the cam(s) 47 can also be located outside the center, as shown in FIG. 7c. Also visible is a receiving element 44, which drives the closing element 41 during movement from the first to the second position (and vice versa). The receiving element 44 is also sketched-in centrally here; embodiments in which the receiving element 44 is arranged off-center are possible. It is also possible to have more than one receiving element. In FIG. 7c, the closing element 41 has a concavity at which the closing element 41 expands when the cams 47 pass over.

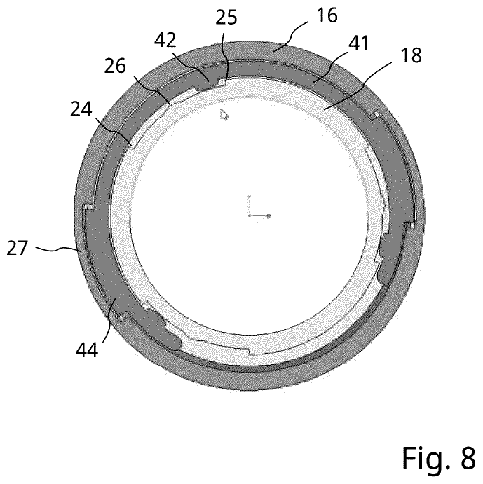

FIG. 8 shows a further embodiment of the closing element 41 for which the base body 18 includes three central cams, which act radially. Such an embodiment further includes three cams 42 on the closing element 41, which act radially. If the cams 26, 42 meet during movement from the first to the second position (or vice versa), the closing element also expands (temporarily) radially.

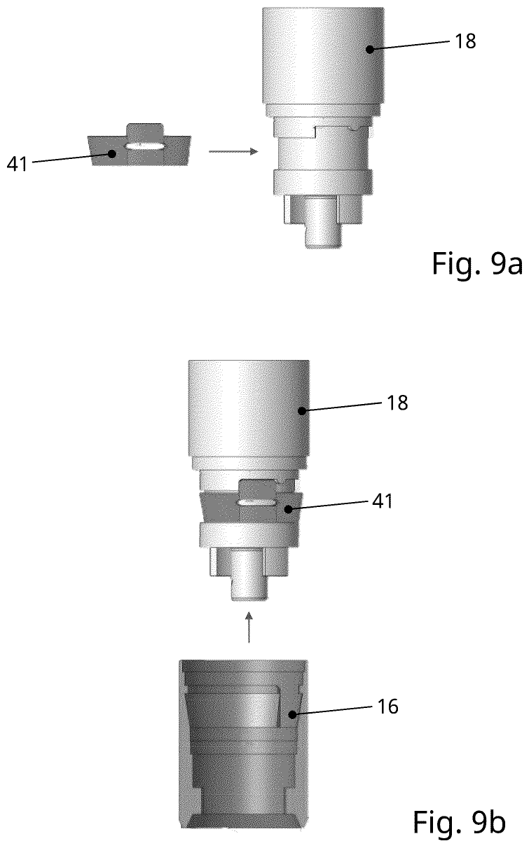

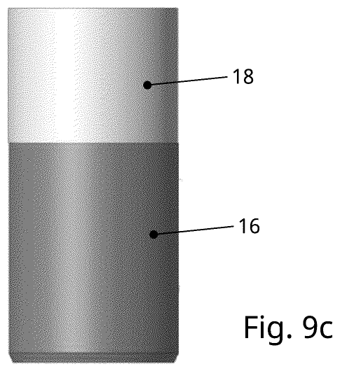

To mount a connection element 11, the following steps are performed, as illustrated in FIGS. 9a-9c:
providing the base body 18;
slipping the closing element 41 over the base body 18 in the radial direction; and
slipping the locking part 16 over the base body 18 with the closing element 41 in the axial direction.

In at least one embodiment, the closing element 41 is slipped over axially.

In at least one embodiment, the closing element 41 is first inserted into the locking part 16 (axially). This combination of parts is then placed on the base body 18.

The connection element 11 thus comprises three components in the assembled state. The locking part 16 is rotated by a certain angle to close the bayonet mount and to connect the connection element 11 to the corresponding sensor 11. The defined angle of rotation is positively transmitted to the closing element 41 via the radial groove in the locking part 16, and the angle of rotation of the closing element 41 is limited by the recesses 24, 25 in the base body 18. The axial cam 42 generates the haptic resistance via the central cam 26 of the base body 18, which also ensures that the angle of rotation is limited. There are also guide surfaces on the locking part 16 and the base body 18 to ensure guidance between the two components.

The locking part 16 and the base body 18 are decoupled by an inserted “closing element.”

Some features of the closing element 41 are listed below:
the closing element 41 is compressed in a resilient manner during mounting and expands in the final position. This means that little pressing force is required when joining;
the closing element 41 is located in a groove introduced into the base body 18 and into the locking part 16;
the closing element 41 has a cam geometry (axial cam 42) which interacts, preferably axially, with a counter-geometry 23 introduced into the base body 18 and thus realizes the functions of end-position locking and haptics;
the closing element 41 can have geometric recesses, whereby the rigidity of the closing element and thus the rotational haptic feedback can be specifically influenced;
the closing element 41 can provide axial locking between the base body 18 and the locking part 16 (by a conical geometry 45 on the closing element 41); and
the closing element 41 is largely independent of geometric changes in the base body 18 and locking part 16.

The shape of the cams 26, 42 on the base body 18 or on the closing element 41 can be arbitrary. Their quantity can be any quantity. There can be several cams in the corresponding groove for limiting the angle of rotation in order to create a haptic locking in the two end positions.

The radial fixation between the locking part 16 and the locking ring 41 can also be located between the base body 18 and locking part 16. The locking mechanism between the locking part 16 and the locking ring 41 can be realized in this arrangement.

The position of the cam can be on the top or bottom (axial) of the closing element 41.

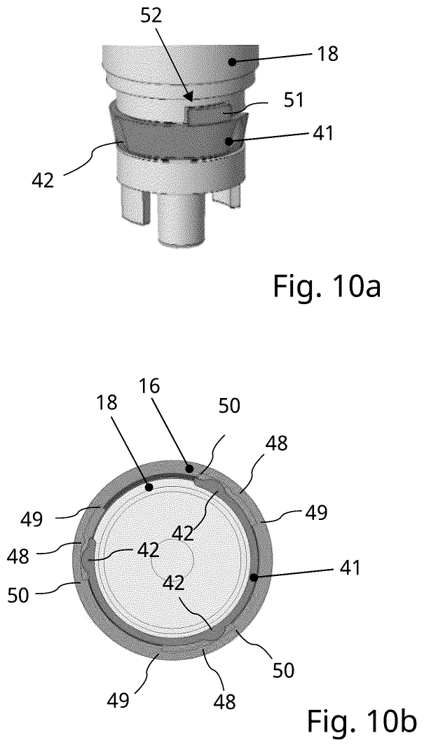

In the embodiments described above, the closing element 41 with the base body 18 ensures a haptic detent behavior. FIGS. 10a and 10b show the embodiment in which the closing element 41 is designed with the locking part 16 to have a haptic detent behavior.

The closing element 41 is firmly fixed to the base body 18; see FIG. 10a. The closing element 41 comprises one or more fixing elements 51, which engage with one (or more) correspondingly designed counter-geometry/geometries, i.e., with the receptacle 52, on the base body 18. The closing element 41 comprises one or more cams 42 for the haptic feedback. The rotatable locking part 16 is mounted over the closing element/base body assembly. The locking part 16 has cams 48 for the haptic detent behavior (for example, arranged centrally) and corresponding stop surfaces 49, 50. During the rotational movement of the locking part 16, the closing element 41 remains firmly on the base body 18, but is compressed in diameter when the cams 42 (on the closing element 41) and 48 (on the locking part 16) pass over. In FIG. 10b, the cams 42, 48 are therefore directed radially. In at least one embodiment, the cams are axially aligned (not shown); then, corresponding recess(es) in the closing element 41 are deformed, in particular in a resilient manner.

All embodiments and designs of the connection element, the method, and the sensor element described above can be combined with one another in each case, provided that this is technically possible.

The present disclosure is an optimization of the prior art of the inductive connector technology available on the sensor market and, in a narrower sense, concerns the mechanical coupling function. Disclosed is a locking ring (“closing element”) which is essentially designed so as to realize a haptic detent behavior and thus an end-position locking of a sensor/connection element connection, in particular, of a bayonet mount. Influencing factors such as material, manufacturing, or geometry-specific fluctuations of the base body 18 and locking part 16 are decoupled by the locking ring 41 and have no influence on the detent behavior. Also, temperature-related expansions are absorbed by the locking ring 41. The locking ring 41 enables axial locking between a housing (“base body 18”) and a locking cylinder (“locking part 16”). Due to the, for example, resilient structure of the closing element 41, manual mounting without mounting tools is possible. The detent behavior (actuating torque) for closing and opening the bayonet mount can be easily adapted using geometric recesses.

We claim:

1. A connection element for connection to a sensor, which is configured to detect a measured variable, the connection element comprising:
a coupling body configured to connect the connection element to the sensor and including an inductive interface for communication with the sensor and for supplying energy to the sensor;
a base body;
a locking part; and
an annular closing element arranged therebetween,
wherein the locking part is rotatably movable with respect to the base body at least between a first position and a second position,
wherein the sensor is connectable to and releasable from the connection element in the first position,
wherein the sensor is locked to the connection element in the second position,
wherein the locking part is mechanically coupled to the closing element, and
wherein the closing element is designed to have a haptic detent behavior with the base body or the locking part and to enable positive, end-position locking in the first and second positions,
wherein the connection element is configured to transmit a value dependent upon the measured variable to a higher-level unit.

2. The connection element according to claim 1, wherein the base body includes the interface.

3. The connection element according to claim 1, wherein the coupling body includes a second locking means configured to be complementary to a first locking means of the sensor and form a bayonet mount.

4. The connection element according to claim 3, wherein the sensor comprises a coupling body,
wherein the coupling body of the sensor or of the connection element comprises at least one protrusion and are configured such that, by introducing the at least one protrusion and the second locking means into the first locking means, in particular into a corresponding recess, of the respective other coupling body, and subsequently rotating the base body with respect to the locking part of the bayonet mount, the coupling bodies are locked relative to each other.

5. The connection element according to claim 1, wherein the closing element is embodied as a not-fully-closed ring.

6. The connection element according to claim 1, wherein the base body includes a guide surface for the closing element,
wherein the closing element includes cams in an axial direction of the connection element, which engage with a counter-geometry on the base body.

7. The connection element according to claim 6, wherein the counter-geometry on the base body includes a first stop surface for the first position and a second stop surface for the second position, and wherein the base body includes a central cam which separates the first position from the second position.

8. The connection element according to claim 1, wherein the closing element is embodied as a resilient element.

9. The connection element according to claim 8, wherein the closing element is embodied as a resilient element including a recess extending in sections along the circumference.

10. The connection element according to claim 7, wherein the closing element is embodied as a resilient element, and
wherein the central cam of the base body is complementary with the resilient design of the closing element so as to provide haptic detent behavior when moving from the first position to the second position, or vice versa.

11. The connection element according to claim 9, wherein the closing element is embodied as a resilient element including a recess extending in sections along the circumference.

12. The connection element according to claim 1, wherein the locking part comprises one or more drive elements, which engage with one or more correspondingly configured receiving elements of the closing element and, when the locking part is moved from the first position to the second position, or vice versa, drives the closing element.

13. The connection element according to the claim 12, wherein the receiving element is embodied as part of the cam as a radial protrusion.

14. The connection element according to claim 1, wherein the closing element is frustoconical in form, and
wherein the locking part includes a corresponding axial conical groove and a projection, and the locking part is axially secured relative to the base body by the projection on the wider part of the closing element.

15. The connection element according to claim 1, wherein the closing element is configured at a right angle,
wherein the locking part correspondingly includes a cylindrical free surface, and
wherein a locking contour between the base body and the locking part secures the locking part axially relative to the base body.

16. A method for mounting a connection element according to claim 1, the method comprising:
providing the base body;
introducing the closing element over the base body; and
introducing the locking part over the base body with the closing element in the axial direction.

17. A sensor arrangement, comprising:
a connection element according to claim 1; and
a sensor with first locking means which are configured complementary to the second locking means of the connection element.
